(19) United States
(12) Patent Application Publication
(10) Pub. No.: US 2004/0205667 A1
(43) Pub. Date: Oct. 14, 2004

(54) Method and system for processing text string editing

(76) Inventor: Chung-Yi Hsu, Miaoli (TW)

Correspondence Address: RABIN & BERDO, P.C., Suite 500, 1101 14th Street Street, N.W., Washington, DC, 20005, US

(21) Appl. No.: 10/108,367

(22) Filed: Mar. 29, 2002

(30) Foreign Application Priority Data
Aug. 30, 2001 (TW) 090121533

(51) Int. Cl. G06F 17/24

(52) U.S. Cl. 715/531; 715/511

(57) ABSTRACT

A method and system for processing text string editing is used to process an original text string. The split device is used to split the original text string into N character units that are to be processed, according to the principle of the selected split mode. After that, a processing module is used to respectively perform a different process function on each of the units to be processed, so as to obtain a result unit, which has been separately processed. At the last, the merging unit is used to merge all of the result units that have been processed into one and makes it to be displayed in a display device. The present invention can also repeatedly perform the forgoing processing steps and the merging steps, so as to produce a plurality of picture displaying picture frames and sequentially output to the display device for generating the motion picture effect. It increases the variability on editing the words in sequence order and the diversity of the displaying effects.

This application incorporates by reference of Taiwan application Serial No. 90121533, filed Aug. 30, 2001.

### BACKGROUND OF THE INVENTION

1. Field of the Invention

This invention is relating to a method and system for word processing, and more particularly, relating to a method and system for processing text string editing.

2. Description of Related Art

The computer graphic software usually can additionally edit, beautify, and embellish the drawn pictures and the words. Particularly, after the pictures and words are processed in accordance with many various splendid special effects, a stunning bright effect can usually be created. No matter which one in making work report, enterprise briefing, or business document or pictorial home page for the web internet, a work in those all can be produced with very rich of creativeness and very professional level.

In the aspect of word processing on editing function, the word processing tool provided from the computer graphic software can control the attribution of the word about the factors of shadow, brightness, transparency, color, material, and frame, or perform the treatment on the effects of word deformation, rotation, shifting, and so on. Further still, the special effects of word shape designed by taking the static image process incorporating the motion image process can have more precise control on the object attribution, so as to produce more changeful forms with special effects, such as neon, flame, frame line, and so on. These kinds of special effects allow the word, selected frame, and the object to be very active.

However, when the special effect function and the word tool are taken, the computer graphic system, in general, would treat one text string as one unit for processing. For example, the computer graphic system in the object type will treat one text string as one graphic layer. Since the usual computer graphic system is taking the function on motion process to serve as the whole processing unit, such as the object or graphic layer, it has the main defect that the user can only perform the process on the whole text string.

FIG. 1 is a data processing flow diagram, schematically illustrating the processing method of the conventional computer graphic software on the text string. As shown in FIG. 1, an original text string 10 is composed of a string of words or characters. When a usual computer graphic software is used to perform the word process on editing, the processing action 12 usually can only perform the editing process on the whole original text string 10 and then produce the result text string 14. For example, if the processing action is about the rotation action, then it can only rotate the whole original text string 10 by a certain angle. If one wants to process a single word of the text string, such as rotating each single word of the text string 10 by a different rotating angle, one has to input each the single word one by one in very tedious and complicate manner, so as to treat each single word to be an independent object/graphic layer. And then, one has to perform the processing action one by one on each of the object/graphic layers.

### SUMMARY OF THE INVENTION

It is therefore an objective of the present invention to provide a method and system for processing text string editing, which are used to split words from the text string and edit the manner for displaying, so as to increase the variability of the words in editing sequence order, and the diversity of the word in the displaying effect.

In accordance with the foregoing and other objectives of the present invention, a method for processing text string editing is provided. The method includes the following steps. First, according to a split mode of text string, the original text string is split into a plurality of units that are to be processed. Then, process function is respectively performed on each of the symbol units to be processed, so as to produce a plurality of result units. After that, all the plurality of result units are merged into a single result text string. And after that, the result text string is displayed on the display device.

In accordance with the foregoing and other objectives of the present invention, the invention further provides another a method for processing a text string editing. The method includes: (A) splitting an original text string into a plurality of units that are to be processed. (B) Each of the unit to be processed is respectively performed with a different process, so as to generate a plurality of result units. (C) All of the plurality of the result units is merged into a single displaying picture frame. After that, the steps of (B) and (C) are repeated for a few times, so as to obtain a plurality of displaying picture frames. At the final step of (E), the plurality of displaying picture frames is displayed in sequence, so as to produce the effect of motion picture.

In accordance with the foregoing and other objectives of the present invention, the invention further provides a system for processing text string editing. The system is briefly depicted as follows. The system for processing text string editing comprises a word character split device, a processing module and a merging device. The split device is used to split an original text string into a plurality of units that are to be processed. The processing module device is used to respectively perform a process function on each of the units to be processed, so as to produce a plurality of result units. The merging device is used to merge all of the units to be processed into a single result text string and to output the result text string to a display device. The processing module of the system can also repeatedly performed with the processing steps for a certain times, so as to produce a plurality of the picture displaying frames. The picture displaying frames are displayed in a display device in sequence, so as to produce the effect of motion picture.

### BRIEF DESCRIPTION OF DRAWINGS

The invention can be more fully understood by reading the following detailed description of the preferred embodiments, with reference made to the accompanying drawings, wherein:

FIG. 1 is a data flow diagram, schematically illustrating the conventional computer graphic software, which is used to edit a text string;

FIG. 2 is a data flow diagram, schematically illustrating the word process on editing a text string, according to a first embodiment of the present invention;

FIG. 3 is a flow chart, schematically illustrating the word process on editing a text string, according to the first embodiment of the present invention;

FIG. 4A-4D schematically illustrates the word split modes with respect to the four word character split principles used in the method for processing the text string editing, according to the first preferred embodiment of the present invention;

FIG. 5 is a system block diagram, schematically illustrating the system for processing text string editing, according to the first embodiment of the present invention;

FIG. 6 is a data flow diagram, schematically illustrating the process of editing the text string, so as to produce the effect of motion picture, according to a second embodiment of the present invention; and

FIG. 7 is a flow chart, schematically illustrating the method for processing text string editing, according to a second preferred embodiment of the present invention.

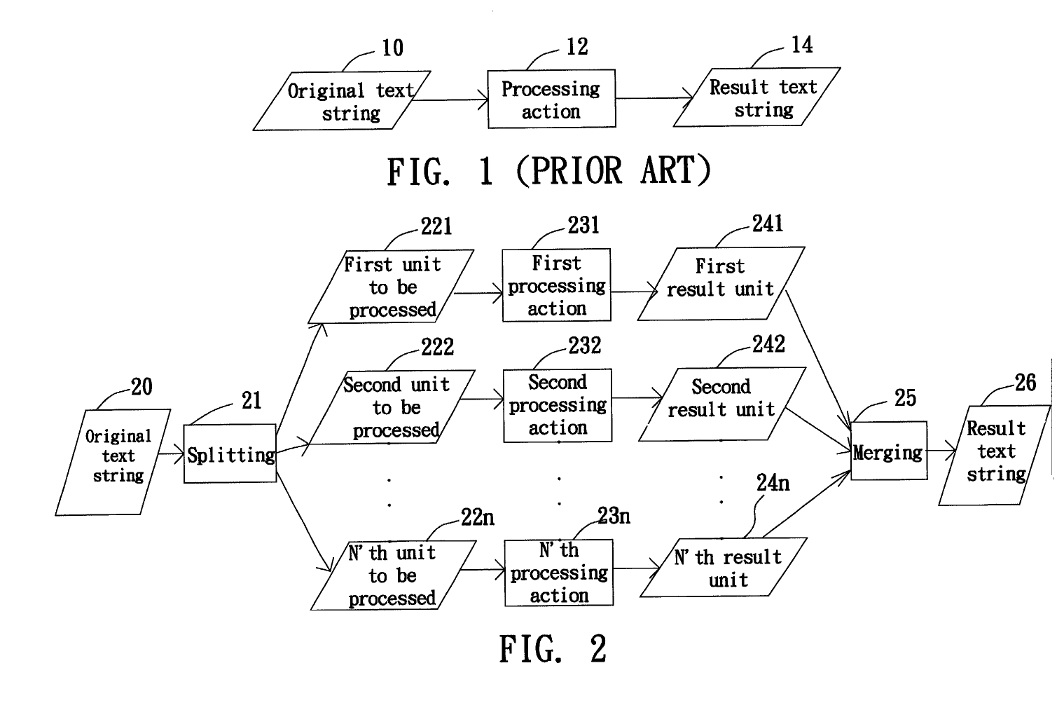

### DETAILED DESCRIPTION OF THE INVENTION

Referring to FIG. 2, FIG. 2 is a data flow diagram, schematically illustrating the word process on editing a text string, according to a first embodiment of the present invention. In FIG. 2, the original text string 20 is composed of a string of word characters. According to the number of byte used to represent a word character, the type of word byte can be divided into to two categories. One is called a single byte character and the other one is called a double byte character. The single byte character is using a single byte to represent a word character. The single byte character mainly includes a half body type having an English character, an Arabic number character, and a blank character, such as a space “0x20” and a skip mark (Tab “0x09”), a new line character, such as aligning mark (“1x0d”) and new line mark (“1x0a”), and so on. The double byte character uses two bytes as a unit to represent one word character, which main includes Chinese character, Japanese character, and so on. The single byte character set (SBCS) is referring to a set including all of the single byte characters. The double byte character set (DBCS) is referring to a set including all of the double byte characters. In the preferred embodiment, the original text string 20 can be composed of the single byte characters, which are arranged in a specific sequence order, or the double byte characters, which are also arranged in a specific sequence order. It can also be composed of a mix of the single byte characters and the double byte characters in any sequence order. In addition, each character of the original text string 20 can be edited with different style, such as an underline or a strike through line. Usually, a double byte character set (DBCS) is directed to a specific language system with reference to a code page, such as Chinese characters (Big-5) or Japanese characters (Shift-JIS). To simply the determination of language systems, a universal character set is developed which is called “Uni-code” to provide a unique number for each character in a variety of language systems and to eliminate the need of a code page. In this case, the processing actions performed upon the split characters are similar to those in the case of DBCS except the absence of a code page, so the discussions are omitted therefore.

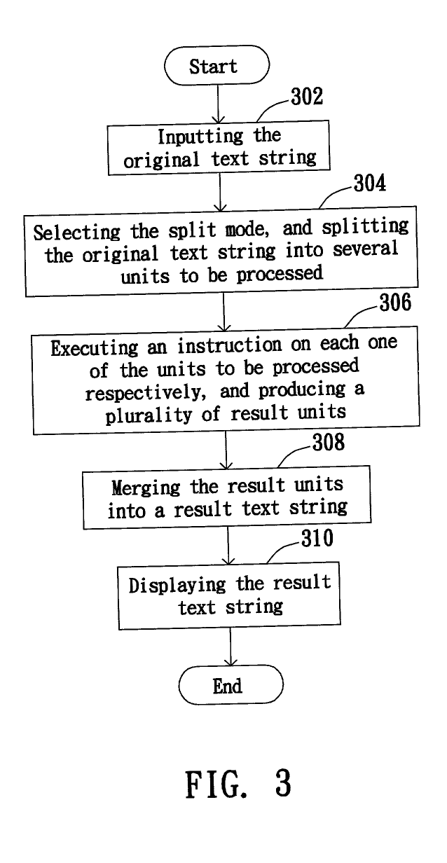

Also referring to FIG. 3, FIG. 3 is a flow chart, schematically illustrating the word process on editing a text string, according to the first embodiment of the present invention. First, the method enters the step 302 for start. The original text string 20 is input. Then in the following step 304, a split mode is chosen. According to the chosen split mode, the original text string 20 is split into a plurality of units that are to be processed. The method for processing text string editing provides a few of split modes. Each of the split modes has a corresponding split principle, and then many character splitting manners are accordingly set.

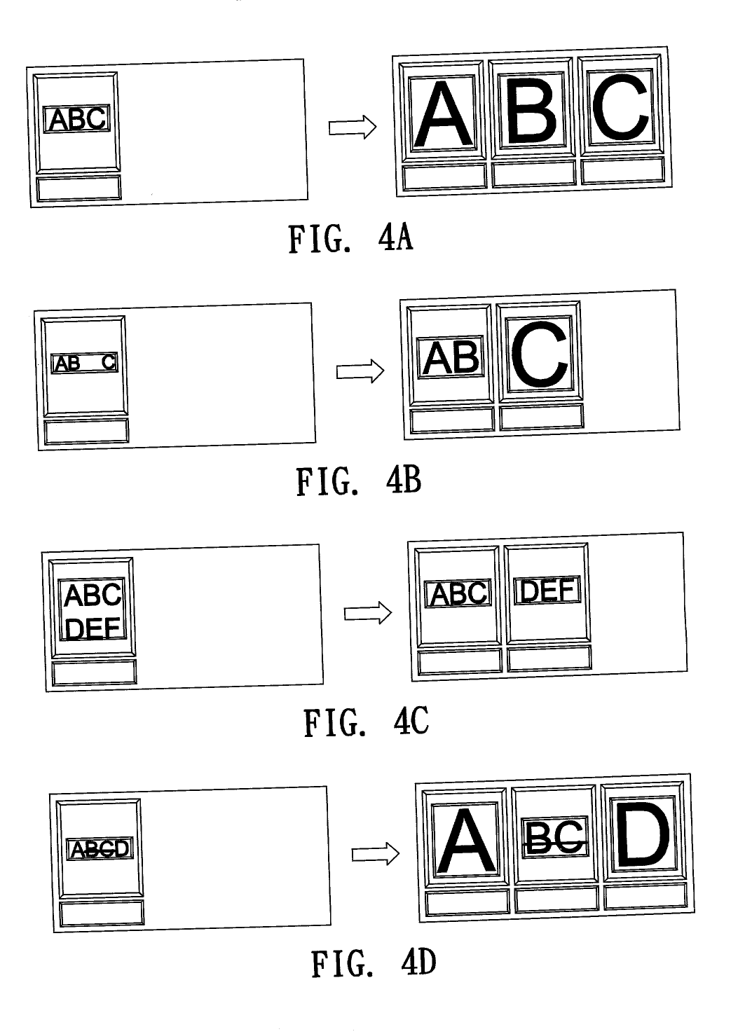

FIGS. 4A-4D are drawings, schematically illustrating the word split modes with respect to the four word character split principles used in the method for processing text string editing, according to the first preferred embodiment of the present invention. The first type of split mode is to split by characters. In the principle of the splitting the character byte, each one of the single byte characters and the double byte characters is equally treated as a unit to be processed. However, the white space character (WC) and the new line character (NC) remain without being processed. In this manner, according to the word character splitting method, it includes respectively splitting each of the single byte characters, also and respectively splitting each of the double byte characters. As shown in FIG. 4A, using a text string of ABC as an example, the text string is composed of three single byte characters. According to the word character splitting method, the text string of ABC shown in the left drawing can be split into three units of A, B, and C, which are to be processed, as shown in the right drawing. A second-type of split mode is to split by words. The word split principle is to treat each of the double byte characters as a unit to be processed. And then, a text string with the white space character WC, the new line character NC, the single byte character of the double byte characters in the front or the back, or even the text string formed by them are also treated as a unit to be processed. However, the white space character WC and the new line character NC are not processed. In accordance with the word split method, it includes that each of the double byte characters is respectively split. In addition, the text string with the white space character WC, the new line character NC, the single byte character of the double byte characters in the front or the back, or the text string formed by them are also respectively split. As shown in FIG. 4B, taking a text string of AB(wc)C as an example, the text string is composed of three single byte characters with one white spacer character wc. According to the word splitting method, the text string of AB(wc)C as shown in the left drawing of FIG. 4B can be split into two units to be processed with one of AB and another one of C. The third type of split mode is to split by lines. The line split principle is that each word line is treated as a unit to be processed. However, for the word lines only having white spacer character WC without the underline or strike through line, those lines are not processed. At the same time, the new line characters NC are also not processed. In this manner, in accordance with the word line splitting method, it includes splitting the original text string 20 according to the new line characters NC, in which the text string between the two adjacent new line characters NC is not a complete white space. As shown in FIG. 4C, taking the text string of ABS(nc)DEF as an example, since the text string is composed of six single byte characters and one new line characters NC, the word line splitting method can split the text string of ABS(nc)DEF as shown in left drawing into two units of ABC and DEF, which are to be processed, as shown in the right drawing.

The fourth type of split mode is to split by styles. The style split principle is that each type of the styles without carrying the new line character NC is treated as one unit to be processed. At the same time, when it is under the situation with the same style, no matter whether or not the text string carries the new line character NC, the whole original text string 20 is treated as a single unit to be processed. However, under the situation having multiple styles, these styles are respectively split. Also and, according to the new line character NC, the same style is split. As shown in FIG. 4D, taking a text string of AD as an example, since the text string carries the single byte characters of BC, which carry the strike through line, the portion of text string BC is different from the single byte characters A and D in style. In accordance with the word style splitting method, the text string of AD as shown in the left drawing is split into A, and D as the three units to be processed. It is worth to be noted for some specific problems that can be solved by going through the word line splitting method. For example, for a display device that does not support the new line action, the objective of new line action can be achieved by using the word line split principle.

As shown in FIG. 2, a splitting processing step 21 is performed on the original text string 20, according to the selected word split mode. The original text string 20 is split into a first unit to be processed 221, a second unit to be processed 222., and the nth unit to be processed. As shown in FIG. 3, the step 306 is that each of all the units to be processed is respectively performed under the processing action instructions, so as to produce a few of result units. In other words, the first unit to be processed 221, a second unit to be processed 222 . . . , and the nth unit to be processed are respectively performed with a first line processing action 231, a second line processing action 232, . . . and the nth line processing action. After that actions, it will produce a first result unit 241, a second result unit 242, . . . , and the Nth result unit 24n. Then, in the step 308, all of the plurality of result units is merged into a result text string. In other words, the first result unit 241, the second result unit 242, . . . , and the Nth result unit 24n are merged through the merging step 25. As a result, a result text string 26 is produced. Here, the result text string 26 still keeps the relative relation position between word characters in the original text string. In the last step 310, the result text string is displayed, and the method for processing text string editing is complete and the goes to stop.

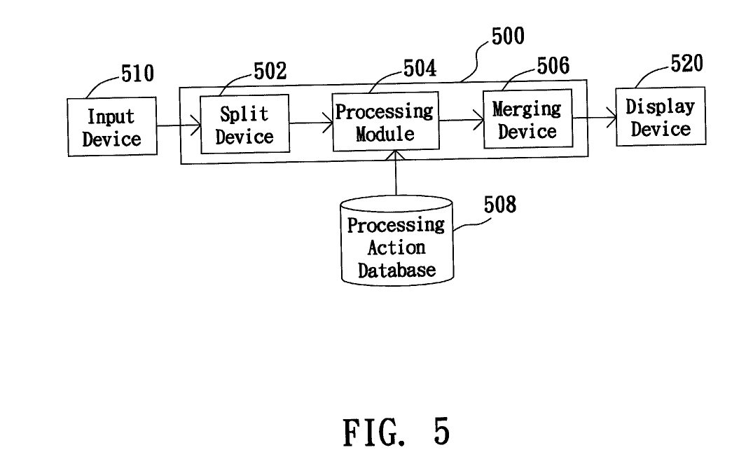

Referring to FIG. 5, FIG. 5 is a system block diagram, schematically illustrating the system for processing text string editing, according to the first embodiment of the present invention. In FIG. 5, the system for processing text string editing is used to process the original text string, so as to increase the variability of arranging the words in sequence order and combination, and the diversity of displaying special effects. As shown in FIG. 5, the system for processing text string editing 500 includes a split device 502, a processing module 504, and a merging device 506. The split device 502 is used to receive the original text string 20, which is transmitted from an inputting device 510, and to split the original text string 20 into a number of units to be processed. The processing module 504 and a data bank 508 of function about processing action are coupled to each other, in which the data bank 508 of function about processing action includes a number of functions for processing action and can respectively apply each one of the functions for processing action to each one of the units to be processed. Processing action for each one of the units to be processed is separately performed, so as to generate a number of result units. The merging device 506 is used to merge multiple result units into a result text string 26, and outputs the result text string 26 to a display device 520.

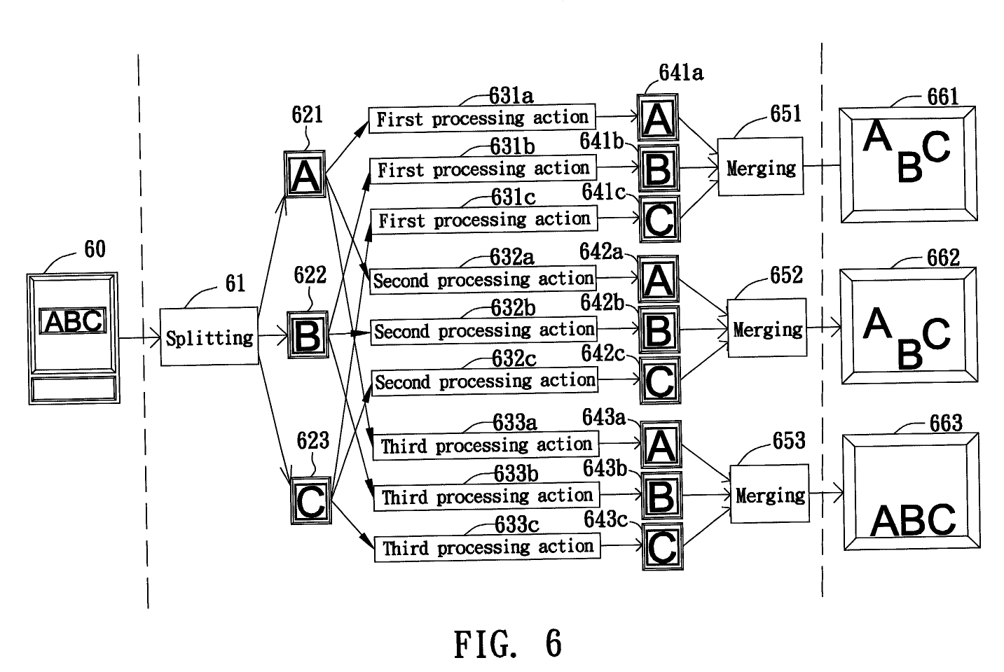

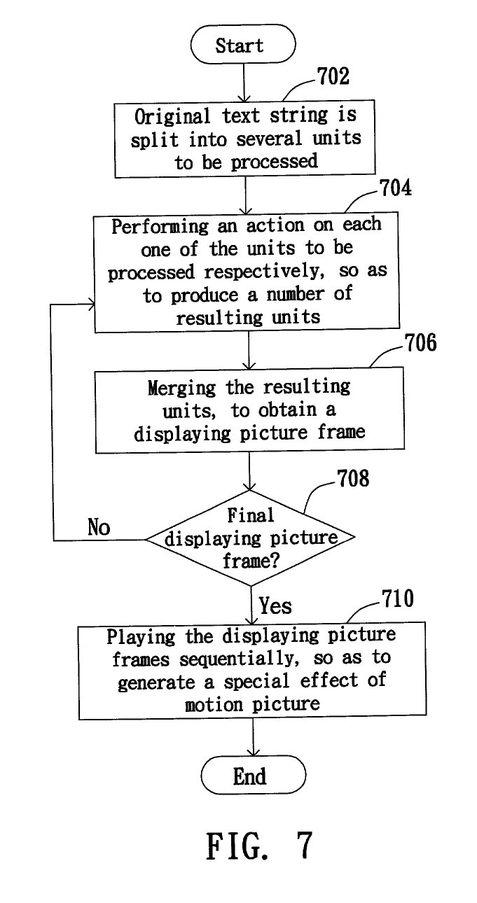

Referring to FIG. 6, it is a data flow diagram, schematically illustrating the process of editing the text string, so as to produce the effect of motion picture, according to a second embodiment of the present invention. Also referring to FIG. 7, it is a flow chart, schematically illustrating the method for processing text string editing, according to a second embodiment of the present invention. When the user inputs the original text string 60 and also selects an instruction for creating 3-frame drop effect for active text string, the procedure starts to enter the step 702. The original text string 60 is then split into three units to be processed 621, 622, and 623 under the character splitting procedure 61. After then in the step 704, the processing action is respectively performed on each one of the units to be processed, so as to produce a number of result units. First, the first processing actions 631a, 631b, and 631c are respectively performed on each of the units to be processed 621, 622, and 623, e.g. respectively shifting a1, b1, and c1 and positioning in frame 1 such that the result units 641a, 641b, and 641c are produced. After then in the step 706, a merging procedure 651 is performed, in which the result units 641a, 641b, and 641c are merged together and form a displaying picture frame 661. In the mean time, in the step 708, the displaying picture frame 661 is judged to be whether or not the final displaying picture frame, so as to decide whether or not to repeat the foregoing processing steps. Since the displaying picture frame 661 is the first picture frame, the procedure goes back to the step 704, and then respectively process again on the units to be processed 621, 622, and 623 by the second processing actions 632a, 632b, and 632c, e.g. respectively shifting a2, b2, and c2 and then positioning in frame 2 so as to form the result units 642a, 642b, and 642c. After then in the step 706, the merging process 652 is performed and the result units 642a, 642b, and 642c are merged into a displaying picture frame 662. Since the displaying picture frame 662 is not the final displaying picture frame, the procedure goes back to the step 704 again for respectively performing the third processing actions 633a, 633b, and 633c on the units to be processed 621, 622, and 623, e.g. respectively shifting a3, b3, and c3 and then positioning in frame 3 so as to form the result units 643a, 643b, and 643c. After then in the step 706, the merging process 653 is performed and the result units 643a, 643b, and 643c are then merged into a displaying picture frame 663. Then, the procedure goes to the step 708, in which the displaying picture frame 663 is judged that whether or not it is the final displaying picture frame. After the final displaying picture frame is found, the procedure then goes to the step 710. In the step 710, those multiple displaying picture frames produced by the foregoing repeating steps can be sequentially displayed by a control of the displaying time point, so that a displaying with motion picture effect is achieved. As shown in FIG. 6, the displaying picture frames 661, 662, and 663 are sequentially displayed, so as to create, for example, drop effect for active text string.

Therefore, the method for processing text string editing according to the present invention can be applied to split an original text string into a number of units to be processed. After then, each one of the units to be processed can be separately processed with a further process of action. In addition to the foregoing drop effect for active text string, the other special effect of motion picture can also be performed by a batch manner, in which an instruction is applied in once to several units to be processed and then a number of different displaying picture frames are produced with respect to the different display of result test strings. In addition, by a control of displaying time points for the displaying picture frame, the picture frames are sequentially displayed, so as to produce the special effect of motion picture for the text string with more diversification, and then achieve to the rich displaying effect.

In the foregoing embodiment of the present invention about method for processing text string editing has several advantages as follows:

1. Convenience: The user only needs to input a text string to the inputting device, and gives the instruction. Then, it can start to split the text string and perform the process for editing the displaying text string in diversifying forms. At the same time, the result text string can also keep the same relative position between words as the original text string.

2. Variation: The word after the splitting process can be produced with more special effect than the special effect for a single text string. The degree of freedom of creation is significantly increased. It can be performed for respectively adjusting each word according to the individual word type.

3. Transformation: In some specific problems, the character splitting process can provide several different ways of solution. For example, for a displaying device that does not support the function of changing line, it can then use the splitting process with a line unit to achieve the purpose of changing the line and aligning the line.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for processing text string editing, used to process an original text string, the method comprising:
splitting the original text string into a plurality of units to be processed, according to a split mode;
respectively performing a process function on each one of the units to be processed, so as to produce a plurality of result units;
merging the result units into a result text string; and
outputting the result text string to a display device.

2. The method according to claim 1, wherein the original text string is composed of a plurality of character units, and the character units include elements in a single byte character set and/or a double byte character set.

3. The method according to claim 1, wherein the original text string is composed of a plurality of character units, and the character units include elements in a Unicode character set.

4. The method according to claim 2, wherein the split mode is to split by characters.

5. The method according to claim 1, wherein the original text string includes a space character.

6. The method according to claim 5, wherein the split mode is to split bywords.

7. The method according to claim 1, wherein the original text string includes a new line character.

8. The method according to claim 6, wherein the split mode is to split by lines.

9. The method according to claim 1, wherein the original text string includes a plurality of styles.

10. The method according to claim 6, wherein the split mode is to split by styles.

11. A method for processing text string editing, used to process an original text string, the method comprising the steps of:
(a) splitting the original text string into a plurality of units to be processed, according to a split mode;
(b) respectively performing a process function on each one of the units to be processed, so as to produce a plurality of result units;
(c) merging the result units into one displaying picture frame;
(d) repeating the steps of (b) and (c), so as to obtain a plurality of displaying picture frames; and
(e) sequentially playing the displaying picture frames, so as to have a special effect of motion picture.

12. The method according to claim 11, wherein the original text string is composed of a plurality of character units, and the character units include elements in a single byte character set and/or a double byte character set.

13. The method according to claim 11, wherein the original text string is composed of a plurality of character units, and the character units include elements in a Unicode character set.

14. The method according to claim 12, wherein the split mode is to split by characters.

15. The method according to claim 11, wherein the original text string includes a space character.

16. The method according to claim 15, wherein the split mode is to split by words.

17. The method according to claim 11, wherein the original text string includes a new line character.

18. The method according to claim 17, wherein the split mode is to split by lines.

19. The method according to claim 11, wherein the original text string includes a plurality of styles.

20. The method according to claim 19, wherein the split mode is to split by styles.

21. A system for processing text string editing, used to process an original text string, the system comprising:
a split device, used to split the original text string into a plurality of units to be processed;
a processing module, used to respectively perform a process function on each one of the units to be processed, so as to produce a plurality of result units;
a merging device, used to merge the result units into a result text string, and output the result text string to a display device.

22. A system for processing text string editing, used to process an original text string, the system comprising:
a split device, used to split the original text string into a plurality of units to be processed;
a merging device; and
a processing module, used to perform the following steps of:
(a) respectively performing a process function on each one of the units to be processed, so as to produce a plurality of result units;
(b) using the merging device to merge the result units into one displaying picture frame; and
(c) repeating the steps of (a) and (b), so as to obtain a plurality of displaying picture frames, and then sequentially playing the displaying picture frames, so as to have a special effect of motion picture.

23. A recording medium, which is readable by a computer and is used to record a text string by a method for processing text string editing, used to process an original text string, the method for editing text string comprising the steps of:
inputting the original text string;
selecting a split mode, and splitting the original text string into a plurality of units to be processed, according to the split mode;
executing a processing instruction, to respectively perform a process function on each one of the units to be processed, so as to produce a plurality of result units;
merging the result units into a result text string; and
outputting the result text string to a display device.

24. A recording medium, which is readable by a computer and is used to record a text string by a method for processing text string editing, used to process an original text string, the method for editing text string comprising the steps of:
(a) splitting the original text string into a plurality of units to be processed, according to a split mode;
(b) respectively performing a process function on each one of the units to be processed, so as to produce a plurality of result units;
(c) merging the result units into one displaying picture frame;
(d) repeating the steps of (b) and (c), so as to obtain a plurality of displaying picture frames; and
(e) sequentially playing the displaying picture frames, so as to have a special effect of motion picture.
